(19) United States
(12) Patent Application Publication
(10) Pub. No.: US 2004/0118509 A1
(43) Pub. Date: Jun. 24, 2004

(54) Concentrations to improve surface adhesion characteristics of polyacetal-based compositions

(76) Inventors: Edmund Arthur Flexman, Wilmington, DE (US); Stefan Greulich, Wilmington, DE (US); Kimberly L. Richmann, St. Louis, MO (US)

Correspondence Address: E I DU PONT DE NEMOURS AND COMPANY, LEGAL PATENT RECORDS CENTER, BARLEY MILL PLAZA 25/1128, 4417 LANCASTER PIKE, WILMINGTON, DE, 19805, US

(21) Appl. No.: 10/723,655

(22) Filed: Nov. 26, 2003

Related U.S. Application Data
(60) Provisional application No. 60/435,091, filed on Dec. 20, 2002.

(51) Int. Cl. B28B 3/20

(52) U.S. Cl. 156/242; 264/176.1; 264/328.1

(57) ABSTRACT

This invention relates a method for forming a polyacetal blend substrate having at least one discontinuous or co-continuous layer adhered thereon, wherein the method utilizes concentrates to deliver the polymers that provide enhanced surface adhesion.

This application claims the benefit of U.S. Provisional Application No. 60/435,091 filed Dec. 20, 2002 which is incorporated by reference herein for all purposes as if fully set forth.

### BACKGROUND OF THE INVENTION

1. Field of the Invention

This invention relates to a method for forming a polyacetal blend substrate having at least one discontinuous or co-continuous layer adhered thereon, wherein the method utilizes concentrates that provide enhanced surface adhesion, thereby allowing the application of the at least one layer such as, for example, a coating of paints, glues, or metal, or overmolding by thermoplastic elastomers and the like.

2. Description of Related Art

Polyacetal compositions are useful as engineering resins due to the positive physical properties they possess, thus allowing polyacetal compositions to be a preferred material for a wide variety of end-uses. Articles made from polyoxymethylene compositions typically possess extremely desirable physical properties such as high stiffness, high strength, good tribology and solvent resistance. However because of their highly crystalline surface, such articles also have low levels of adhesion, wherein it is difficult, if not impossible to paint, glue, or print on such surfaces, overmold such articles with thermoplastic polymers or adhere some other type of layer to the surface of the substrate.

Polyacetal compositions, which are also referred to in the art as polyoxymethylene compositions, are generally understood to include compositions based on homopolymers of formaldehyde or of cyclic oligomers of formaldehyde, for example trioxane, the terminal groups of which are end-capped by esterification or etherification, as well as copolymers of formaldehyde or of cyclic oligomers of formaldehyde, with oxyalkylene groups having at least two adjacent carbon atoms in the main chain, the terminal groups of which copolymers can be hydroxyl terminated or can be end-capped by esterification or etherification. The proportion of the comonomers can be up to 20 weight percent.

Compositions based on polyoxymethylene of relatively high molecular weight, for example 20,000 to 100,000, are useful in preparing semi-finished and finished articles by any of the techniques commonly used with thermoplastic materials, such as, for example, compression molding, injection molding, extrusion, blow molding, stamping and thermoforming.

Polyacetal has been among the last of the crystalline engineering resins to be blended with other resins. Commercial blends of polyacetal and other resins, for purposes other than toughening, are relatively unknown. Generally, when polyacetal is blended with another resin, the physical properties of the polyacetal are significantly decreased.

Finished products made from such polyacetal compositions possess extremely desirable physical properties, including, but not limited to, high stiffness, strength and solvent resistance.

The present invention provides a method to efficiently deliver the adhesion modifying components to improve the adhesion of the polyacetal major component in concentrated form to the production process. The present invention is advantageous because it allows the end user to determine the amount of concentrate necessary, such that minimal amounts of the concentrate may be used to meet commercial needs, while maximizing the other properties of the resin matrix.

### SUMMARY OF THE INVENTION

The present invention relates to a method for producing a substrate comprising the steps of:

(a) forming a matrix comprising about 85%-wt. to about 98%-wt. of a polyacetal polymer;

(b) adding about 2% to about 15% of a concentrate to the polyacetal matrix; and

(c) forming the substrate.

The present invention further relates to a process of making an article comprising the steps of:

(i) forming the substrate in the above method;

(ii) adhering at least one additional layer to the substrate.

Still further, the present invention relates to articles made from the above-noted process.

### DETAILED DESCRIPTION OF THE INVENTION

The present invention relates to a method for producing a substrate comprising the steps of:

(a) forming a matrix comprising about 85%-wt. to about 98%-wt. of a polyacetal polymer;

(b) adding about 2% to about 15% of a concentrate to the polyacetal matrix; and

(c) molding the substrate.

The present invention further relates to a process of making an article comprising the steps of:

(i) forming the substrate as noted above; and

(ii) adhering at least one layer to the substrate.

Still further, the present invention relates to articles made from the above-noted process.

Typically, polyacetal-based substrates have low levels of adhesion at their surface, therefore it is difficult to make layered articles for commercial purposes such as, for example, “decorated” parts for the automotive industry including, but not limited to, soft touch buttons and switches; household appliances; consumer products including, but not limited to, painted ski bindings and chrome plated caps for perfume bottles; construction parts; furniture, fashion; and industrial uses including, but not limited to, high friction conveyors and sealing clips.

The term “layer(s)” or “layered” or a derivative thereof, as used herein, is meant to refer to the overmolding layer and/or the layer of paint or glue and the like being adhered to the substrate without pretreatment of the substrate other than possibly cleaning.

The terms “adhesion”, “adhered”, “adhering” or any derivative thereof, shall mean the adhesion that exists between the surfaces of the substrate and the at least one additional layer, in which the adhesive secures the adherends by means of interlocking forces, also known as mechanical adhesion. The level of adhesion, mechanical binding or interlocking can be determined according to either the peel test or cross-hatch test described herein or other test deemed appropriate for the type of adherent used. Thus, according to the peel test, adhered elastomers or other overmoldings must have a value of at least 2 pounds per linear inch, whereas according to the cross-hatch test, adhered paints or other printing decorative layers suitable adhesion shows a result of “2” or better.

The term “discontinuous” as used herein refers to a layer (as defined herein) that is adhered to the substrate in a non-continuous or partial manner over the surface area of the substrate. For example, printing, painting, overmolding, etc. in a pattern which is not continuous and/or does not cover the entire substrate such as, but not limited to stripes, polka dots, grids, etc. are a discontinuous layer. The discontinuous layer is any layer that cannot be classified as “co-continuous”.

The term “co-continuous” as used herein refers to a layer (as defined herein) that adheres to the substrate (i.e. which is co-continuous with the “layer”) in an uninterrupted or continuous manner over the surface area of the substrate. For example, dip-coating, painting or chrome-plating, etc. of the surface area of the substrate would form a co-continuous layer with the substrate. The co-continuous layer adheres to the surface area of the substrate and there is not a break in the layer (i.e. the layer is a solitary unit).

As used herein the term “semi-crystalline” shall refer to a polymeric material processing a melting point when heated in a DSC, in contrast to a Tg.

Polyacetal Component

The polyacetal component of the substrate includes homopolymers of formaldehyde or of cyclic oligomers of formaldehyde, the terminal groups of which are end-capped by esterification or etherification, and copolymers of formaldehyde or of cyclic oligomers of formaldehyde and other monomers that yield oxyalkylene groups with at least two adjacent carbon atoms in the main chain, the terminal groups of which copolymers can be hydroxyl terminated or can be end-capped by esterification or etherification.

Typically, substrates according to the present invention comprise about 85-98% weight percent of an polyacetal polymer.

The polyacetal used in the substrates of the present invention can be branched or linear and will generally have a number average molecular weight in the range of about 10,000 to 100,000, preferably about 20,000 to about 90,000, and more preferably about 25,000 to about 70,000. The molecular weight can be measured by gel permeation chromatography in m-cresol at 160° C. using a DuPont PSM bimodal column kit with nominal pore size of 60 and 100 A. In general, high molecular weight polyacetals segregate from the second phase material to a greater degree, and thus may show greater adhesion. Although polyacetals having higher or lower molecular weight averages can be used, depending on the physical and processing properties desired, the polyacetal weight averages mentioned above are preferred to provide the optimum balance of surface adhesion with other physical properties such as high stiffness, high strength and solvent resistance.

As an alternative to characterizing the polyacetal by its number average molecular weight, it can be characterized by its melt flow rate. Polyacetals which are suitable for use in the blends of the present invention will have a melt flow rate (measured according to ASTM-D-1238, Procedure A, Condition G with a 1.0 mm (0.0413) diameter orifice of 0.1-40 grams/10 minutes). Preferably, the melt flow rate of the polyacetal used in the blends of the present invention will be from about 0.5-35 grams/10 minutes. The most preferred polyacetals with a melt flow rate of about 1-20 gram/10 minutes.

As indicated above, the polyacetals used in the substrates of the present invention can be either a homopolymer, a copolymer or a mixture thereof. Copolymers can contain one or more comonomers, such as those generally used in preparing polyacetal compositions. Comonomers more commonly used include alkylene oxides of 2-12 carbon atoms and their cyclic addition products with formaldehyde. The quantity of comonomers will be no more than 20 weight percent, preferably not more than 15 weight percent, and most preferably about 2 weight percent. The most preferred comonomer is ethylene oxide. Generally, polyacetal homopolymer is preferred over copolymer because of its greater stiffness and strength. Preferred polyacetal homopolymers include those whose terminal hydroxyl groups have been end-capped by a chemical reaction to form ester or ether groups, preferably acetate or methoxy groups, respectively.

The polyacetal may also contain those additives, ingredients, and modifiers that are known to be added to polyacetal, such as those stabilizers well known within the art, such as, thermal and chemical stabilizers, antioxidants, lubricants, mold release agents, nucleating agents at low levels and glass fibers or flakes, minerals at higher levels and the like.

Concentrate Component

Typically, the concentrate component according to the present invention comprises about 0%-wt. to about 40%-wt. of a thermoplastic polyurethane and about 20%-wt. to about 80%-wt., preferably about 50%, of an amorphous or semi-crystalline polymer.

The thermoplastic polyurethanes suited for use in the blends of the present invention can be selected from those commercially available or can be made by processes known in the art. (See, for example, Rubber Technology, 2nd edition, edited by Maurice Morton (1973), Chapter 17, Urethane Elastomers, D. A. Meyer, especially pp. 453-6). Thermoplastic polyurethanes are derived from the reaction of polyester or polyether polyols with diisocyanates and optionally also from the further reaction of such components with chain-extending agents such as low molecular weight polyols, preferably diols, or with diamines to form urea linkages. Thermoplastic polyurethanes are generally composed of soft segments, for example polyether or polyester polyols, and hard segments, usually derived from the reaction of the low molecular weight diols and diisocyanates. While a thermoplastic polyurethane with no hard segments can be used, those most useful will contain both soft and hard segments.

In the preparation of the thermoplastic polyurethanes useful in the blends of the present invention, a polymeric soft segment material having at least about 500 and preferably from about 550 to about 5,000 and most preferably from about 1,000 to about 3,000, such as a dihydric polyester or a polyalkylene ether diol, is reacted with an organic diisocyanate in a ratio such that a substantially linear polyurethane polymer results, although some branching can be present. A diol chain extender having a molecular weight less than about 250 may also be incorporated. The mole ratio of isocyanate to hydroxyl in the polymer is preferably from about 0.95 to 1.08 more preferably 0.95 to 1.05, and most preferably, 0.95 to 1.00. In addition, monofunctional isocyanates or alcohols can be used to control molecular weight of the polyurethane.

Suitable polyester polyols include the polyesterification products of one or more dihydric alcohols with one or more dicarboxylic acids. Suitable polyester polyols also include polycarbonate polyols. Suitable dicarboxylic acids include adipic acid, succinic acid, sebacic acid, suberic acid, methyladipic acid, glutaric acid, pimelic acid, azelaic acid, thiodipropionic acid and citraconic acid and mixtures thereof, including small amounts of aromatic dicarboxylic acids. Suitable dihydric alcohols include ethylene glycol, 1,3- or 1,2-propylene glycol, 1,4-butanediol, 1,3-butanediol, 2-methylpentanediol-1,5, diethylene glycol, 1,5-pentanediol, 1,5-hexanediol, 1,2-dodecanediol, and mixtures thereof.

Further, hydroxycarboxylic acids, lactones, and cyclic carbonates, such as epsilon-caprolactone and 3-hydroxybutyric acid can be used in the preparation of the polyester.

Preferred polyesters include poly(ethylene adipate), poly(1,4-butylene adipate), mixtures of these adipates, and poly epsilon-caprolactone.

Suitable polyether polyols include the condensation products of one or more alkylene oxides with a small amount of one or more compounds having active hydrogen containing groups, such as water, ethylene glycol, 1,2- or 1,3-propylene glycol, 1,4-butanediol and 1,5-pentanediol and mixtures thereof. Suitable alkylene oxide condensates include those of ethylene oxide, propylene oxide and butylene oxide and mixtures thereof. Suitable polyalkylene ether glycols may also be prepared from tetrahydrofuran. In addition, suitable polyether polyols can contain comonomers, especially as random or block comonomers, ether glycols derived from ethylene oxide, 1,2-propylene oxide and/or tetrahydrofuran (THF). Alternatively, a THF polyether copolymer with minor amounts of 3-methyl THF can also be used.

Preferred polyethers include poly(tetramethylene ether) glycol (PTMEG), poly(propylene oxide) glycol, and copolymers of propylene oxide and ethylene oxide, and copolymers of tetrahydrofuran and ethylene oxide. Other suitable polymeric diols include those which are primarily hydrocarbon in nature, e.g., polybutadiene diol.

Suitable organic diisocyanates include 1,4-butylene diisocyanate, 1,6-hexamethylene diisocyanate, cyclopentylene-1,3-diisocyanate, 4,4′-dicyclohexylmethane diisocyanate, isophorone diisocyanate, cyclohexylene-1,4-diisocyanate, 2,4-toluene diisocyanate, 2,6-toluene diisocyanate, isomeric mixtures of 2,4- and 2,6-toluene diisocyanate, 4,4′-methylene bis(phenylisocyanate),2,2-diphenylpropane4,4′-diisocyanate, p-phenylene diisocyanate, m-phenylene diisocyanate, xylene diisocyanate, 1,4-naphthylene diisocyanate, 1,5-naphthylene diisocyanate, 4,4′-diphenyl diisocyanate, azobenzene-4,4′-diisocyanate, m- or p-tetramethylxylene diisocyanate, and 1-chlorobenzene-2,4-diisocyanate. 4,4′-methylene bis(phenylisocyanate), 1,6-hexamethylene diisocyanate, 4,4′-dicyclohexylmethane diisocyanate and 2,4-toluene diisocyanate are preferred.

Secondary amide linkages including those derived from adipyl chloride and piperazine, and secondary urethane linkages, including those derived from the bis-chloroformates of PTMEG and/or butanediol, can also be present in the polyurethanes.

Dihydric alcohols suitable for use as chain extending agents in the preparation of the thermoplastic polyurethanes include those containing carbon chains which are either uninterrupted or which are interrupted by oxygen or sulfur linkages, including 1,2-ethanediol, 1,2-propanediol, isopropyl-a-glyceryl ether, 1,3-propanediol, 1,3-butanediol, 2,2-dimethyl-1,3-propanediol, 2,2-diethyl-1,3-propanediol, 2-ethyl-2-butyl-1,3-propanediol, 2-methyl-2,4-pentanediol, 2,2,4-trimethyl-1,3-pentanediol, 2-ethyl-1,3-hexanediol, 1,4-butanediol, 2,5-hexanediol, 1,5-pentanediol, dihydroxycyclopentane, 1,6-hexanediol, 1,4-cyclohexanediol, 4,4′-cyclohexanedimethylol, thiodiglycol, diethylene glycol, dipropylene glycol, 2-methyl-1,3-propanediol, 2-methyl-2-ethyl-1,3-propanediol, dihydroxyethyl ether of hydroquinone, hydrogenated bisphenol A, dihydroxyethyl terephthalate and dihydroxymethyl benzene and mixtures thereof. Hydroxyl terminated oligomers of 1,4-butanediol terephthalate can also be used, giving a polyester-urethane-polyester repeating structure. Diamines can also be used as chain extending agents giving urea linkages. 1,4-butanediol, 1,2-ethanediol and 1,6-hexanediol are preferred.

In the preparation of the thermoplastic polyurethanes, the ratio of isocyanate to hydroxyl should be close to unity, and the reaction can be a one step or a two step reaction. Catalysts can be used, and the reaction can be run neat or in a solvent.

The moisture content of the blend, in particular of the thermoplastic polyurethane, can influence the results achieved. Water is known to react with polyurethanes, causing the polyurethane to degrade, thereby lowering the effective molecular weight of the polyurethane and lowering the inherent and melt viscosity of the polyurethane. Accordingly, the drier the better. In any event, the moisture content of the blend, and of the individual components of the blend, should contain less than 0.2 percent by weight of water, preferably less than 0.1 percent, especially when there is no opportunity for the water to escape, for example during an injection molding process and other techniques of melt processing.

The thermoplastic polyurethane can also contain those additives, ingredients, and modifiers known to be added to thermoplastic polyurethane.

The at least one amorphous or semi-crystalline thermoplastic polymer of the concentrate may be selected from those thermoplastic polymers that are generally used by themselves, or in combination with others, in extrusion and injection molding processes. These polymers are known to those skilled in the art as extrusion and injection molding grade resins, as opposed to those resins that are known for use as minor components (i.e., processing aids, impact modifiers, stabilizers) in polymer compositions.

The polyacetal/non-acetal thermoplastic polymer blend substrate of the present invention contains a region, on or near the surface of the substrate, where the non-acetal polymer typically resides to promote adhesion. The non-acetal thermoplastic polymer resides in this particular region because in a flowing mixture of immiscible fluids, the lowest viscosity liquid will tend to migrate to the region of highest shear as well as other thermodynamic reasons. For example, in the case of injection molding, the wall of the mold cavity is the region of high shear, and thus, the low viscosity liquid ends up concentrated somewhat on or near the surface of the part.

The amorphous thermoplastic polymer can be incorporated into the composition as one non-acetal thermoplastic polymer or as a blend of more than one non-acetal thermoplastic polymer. Blends of the non-acetal thermoplastic polymers may be used to adjust properties such as, for example, toughness or the compatibility of the major non-acetal resin with the polyacetal. Thermoplastic polyurethanes are typically used for this purpose. Preferably, however, the substrate comprises one non-acetal thermoplastic polymer.

Whether it is incorporated as one non-acetal thermoplastic polymer or as a blend of more than one, the weight percent of all non-acetal thermoplastic polymer(s) in the composition shall not exceed the weight percent ranges given above.

The term “thermoplastic” shall mean the polymer softens, when heated, to a flowable state in which under pressure it can be forced or transferred from a heated cavity into a cool mold and upon cooling in the mold, it hardens and takes the shape of the mold. Thermoplastic polymers are defined in this manner in the Handbook of Plastics and Elastomers (published by McGraw-Hill).

The term “amorphous,” shall mean the polymer has no distinct crystalline melting point, nor does it have a measurable heat of fusion (although with very slow cooling from the melt, or with of sufficient annealing, some crystallinity may develop). The heat of fusion is conveniently determined on a differential scanning calorimeter (DSC). A suitable calorimeter is the DuPont Company's 990 thermal analyzer, Part Number 990000 with cell base II, Part Number 990315 and DSC cell, Part Number 900600. With this instrument, heat of fusion can be measured at a heating rate of 20° C. per minute. The sample is alternately heated to a temperature above the anticipated melting point and cooled rapidly by cooling the sample jacket with liquid nitrogen. The heat of fusion is determined on any heating cycle after the first and should be a constant value within experimental error. Amorphous polymers are defined herein as having a heat of fusion, by this method, of less than 1 cal/gram. For reference, semicrystalline 66 nylon polyamide with a molecular weight of about 17,000 has a heat of fusion of about 16 cal/gm.

The amorphous thermoplastic polymers useful in the present compositions must be melt processible at the temperature at which the polyacetal is melt processed. Polyacetals normally melt processed at melt-temperatures of about 170° C.-260° C., preferably 185° C.-240° C., and most preferably 200° C.-230° C.

The term “melt processible” shall mean that the amorphous thermoplastic polymer must soften or have a sufficient flow such that it can be melt compounded at the particular melt processing temperature for the polyacetal.

The minimum molecular weight of the non-acetal thermoplastic polymer is not considered to be significant for the present blends, provided that the polymer has a degree of polymerization of at least ten and further provided that the polymer is melt processible (i.e., it flows under pressure) at the temperature at which the polyacetal is melt processed. The maximum molecular weight of the non-acetal amorphous thermoplastic polymer should not be so high that the non-acetal amorphous thermoplastic polymer by itself would not be injection moldable by standard present techniques. The maximum molecular weight for a polymer to be used for injection molding processes will vary with each individual, particular non-acetal amorphous thermoplastic polymer. However, said maximum molecular weight for use in injection molding processes is readily discernible by those skilled in the art.

To realize optimum physical properties for the ternary blend, it is recommended that the polyacetal polymer and the non-acetal amorphous thermoplastic polymer have matching melt viscosity values under the same conditions of temperature and pressure.

Non-acetal amorphous thermoplastic polymers, which are injection molding and extrusion grade, suited for use in the blends of the present invention are well known in the art and can be selected from those commercially available or can be made by processes known in the art. Examples of such suitable non-acetal amorphous thermoplastic polymers include, but are not limited to, those selected from the group consisting of styrene acrylonitrile copolymers (SAN), SAN copolymers toughened with a mostly unsaturated rubber, such as acrylonitrile-butadiene-styrene (ABS) resins, or toughened with a mostly saturated rubber, such as acrylonitrile-ethylene-propylene-styrene resins (AES), polycarbonates, polyamides, polyarylates, polyphenyleneoxides, polyphenylene ethers, high impact styrene resins (HIPS), acrylic polymers, imidized acrylic resins, styrene maleic anhydride copolymers, polysulfones, styrene acrylonitrile maleic anhydride resins, and styrene acrylic copolymers, and derivatives thereof. The preferred non-acetal amorphous thermoplastic polymers are selected from the group consisting of styrene acrylonitrile copolymers (SAN), SAN copolymers toughened with a mostly unsaturated rubber, such as acrylonitrile-butadiene-styrene (ABS) resins, or toughened with a mostly saturated rubber, such as acrylonitrile-ethylene-propylene-styrene resins (AES), polycarbonates, polyamides, polyphenyleneoxides, polyphenylene ethers, high impact styrene resins (HIPS), acrylic polymers, styrene maleic anhydride copolymers, and polysulfones, and derivatives thereof. The more preferred amorphous thermoplastic polymers are selected from the group consisting of SAN, ABS, AES, polycarbonates, polyamides, HIPS, and acrylic polymers. Most preferred amorphous thermoplastic polymers are SAN copolymers, ABS resins, AES resins, and polycarbonates.

Amorphous thermoplastic SAN copolymers that are useful herein are well known in the art. SAN copolymer is generally a random, amorphous, linear copolymer produced by copolymerizing styrene and acrylonitrile. The preferred SAN copolymer has a minimum molecular weight of 10,000 and consists of 2040% acrylonitrile, 60-80% styrene. The more preferred SAN copolymer consists of 25-35% acrylonitrile, 65-75% styrene. SAN copolymer is commercially available or it can be readily prepared by techniques well known to those skilled in the art. Amorphous thermoplastic SAN copolymers are further described on pages 214-216 in Engineering Plastics, volume 2, published by ASM INTERNATIONAL, Metals Park, Ohio (1988).

Amorphous thermoplastic ABS and AES resins, which are injection molding and extrusion grade resins, that are useful herein are well known in the art. ABS resin is produced by polymerizing acrylonitrile and styrene in the presence of butadiene, or a mostly butadiene, rubber. Preferably, the ABS resin is comprised of 50-95% of a matrix of SAN, with said matrix being comprised of 2040% acrylonitrile and 60-80% styrene, and 5-50% of a butadiene rubber or a mostly butadiene rubber, such as styrene butadiene rubber (SBR). More preferably, it is comprised of 60-90% of a matrix of SAN, with said matrix more preferably being comprised of 25-35% acrylonitrile and 65-75% styrene, and 10-40% of a butadiene rubber. AES resin is produced by polymerizing acrylonitrile and styrene in the presence of a mostly saturated rubber. The preferred and more preferred AES resin is the same as the preferred and more preferred ABS resin except that the rubber component is comprised of mostly ethylene-propylene copolymer, as opposed to butadiene, or mostly butadiene, rubber. Other alpha-olefins and unsaturated moieties may be present in the ethylene-propylene copolymer rubber. Both ABS and AES copolymers are commercially available or can be readily prepared by techniques well known to those skilled in the art. Amorphous thermoplastic ABS resin is further described on pages 109-114 in Engineering Plastics, referenced above.

Amorphous thermoplastic polycarbonates that are useful herein are well known in the art and can be most basically defined as possessing the repetitive carbonate group —O—C(CO)—O-and in addition will always have the C₆H₄ phenylene moiety attached to the carbonate group (cf. U.S. Pat. No. 3,070,563).

Amorphous thermoplastic polycarbonates are commercially available or can be readily prepared by techniques well known to those skilled in the art. The most preferred aromatic polycarbonate on the basis of commercial availability and available technical information is the polycarbonate of bis(4-hydroxyphenyl)-2,2-propane, known as bisphenol-A polycarbonate. Amorphous thermoplastic polycarbonate is further described on pages 149-150 of Engineering Plastics, referenced above.

The present invention also contemplates the use of polycaprolactones. Polycaprolactones are polymers of a cyclic ester. Preferably, a suitable polycaprolacone is one having a number average molecular weight of about 43,000 and a melt flow of 1.9 g/10 minutes at 80C and 44 psi.

Amorphous and semi-crystalline thermoplastic polyamides that are useful herein are well known in the art. They are described in U.S. Pat. No. 4,410,661. Specifically, these amorphous thermoplastic polyamides are obtained from at least one aromatic dicarboxylic acid containing 8-18 carbon atoms and at least one diamine selected from the class consisting of:

(i) 2-12 carbon normal aliphatic straight-chain diamine,

(ii) 4-18 carbon branched aliphatic diamine, and

(iii) 8-20 carbon cycloaliphatic diamine containing at least one cycloaliphatic, preferably cyclohexyl, moiety, and wherein optionally, up to 50 weight percent of the amorphous polyamide may consist of units obtained from lactams or omega-aminoacids containing 4-12 carbon atoms, or from polymerization salts of aliphatic dicarboxylic acids containing 4-12 carbon atoms and aliphatic diamines containing 2-12 carbon atoms.

The term “aromatic dicarboxylic acid”, shall mean that the carboxy groups are attached directly to an aromatic ring, such as phenylene naphthalene, etc.

The term “aliphatic diamine”, shall mean that the amine groups are attached to a nonaromatic-containing chain such as alkylene.

The term “cycloaliphatic diamine”, shall mean that the amine groups are attached to a cycloaliphatic ring composed of 3-15 carbon atoms. The 6 carbon cycloaliphatic ring is preferred.

Preferred examples of amorphous and/or semi-crystalline thermoplastic polyamides include those with melting points less than 180C, including co- and terpolymers of nylon 6, 610, 612 and the like.

The amorphous and semi-crystalline thermoplastic polyamides exhibit melt viscosities at 200° C. of less than 50,000 poise, preferably less than 20,000 poise measured at a shear stress of 105 dynes/cm². The polyamides are commercially available or can be prepared by known polymer condensation methods in the composition ratios mentioned above. In order to form high polymers, the total moles of the diacids employed should approximately equal the total moles of the diamines employed.

As normally made the 1-aminomethyl-3,5,5-trimethylcyclohexane and the 1,3- or 1,4-bis(aminomethyl)-cyclohexane are mixtures of the cis and trans isomers. Any isomer ratio may be used in this invention.

Bis(p-aminocyclohexyl)methane (PACM hereinafter), which can be used as one of the diamine components in the amorphous thermoplastic polyamides of this invention, is usually a mixture of three stereoisomers. In this invention, any ratio of the three may be used.

In addition to isophthalic acid and terephthalic acid, derivatives thereof, such as the chlorides, may be used to prepare the amorphous thermoplastic polyamide.

The polymerization to prepare the amorphous thermoplastic polyamides may be performed in accordance with known polymerization techniques, such as melt polymerization, solution polymerization and interfacial polymerization techniques, but it is preferred to conduct the polymerization in accordance with the melt polymerization procedure. This procedure produces polyamides having high molecular weights. In the polymerization, diamines and acids are mixed in such amounts that the ratio of the diamine components and the dicarboxylic acid components will be substantially equimolar. In melt polymerization the components are heated at temperatures higher than the melting point of the resulting polyamide but lower than the degradation temperature thereof. The heating temperature is in the range of about 170° C. to 300° C. The pressure can be in the range of vacuum to 300 psig. The method of addition of starting monomers is not critical. For example, salts of combinations of the diamines and acids can be made and mixed. It is also possible to disperse a mixture of the diamines in water, add a prescribed amount of a mixture of acids to the dispersion at an elevated temperature to form a solution of a mixture of nylon salts, and subject the solution to the polymerization.

If desired, a monovalent amine or, preferably, an organic acid, may be added as viscosity adjuster to a mixture of starting salts or an aqueous solution thereof.

Amorphous thermoplastic polyphenylene ethers (PPE) and polyphenylene oxides (PPO) that are useful herein are known in the art. PPE homopolymer is frequently referred to as PPO. The chemical composition of the homopolymer is poly(2,6-dimethyl-4,4-phenylene ether) or poly(oxy-(2-6-dimethyl-4,4-phenylene)): —O-C₆H₂(CH₃)₂— Both PPE and PPO are further described on pages 183-185 in Engineering Plastics, referenced above. Both PPE and PPO are commercially available or can be readily prepared by known techniques by those skilled in the art.

Amorphous thermoplastic high impact styrene (HIPS) resins that are useful herein are well known in the art. HIPS is produced by dissolving usually less than 20 percent polybutadiene rubber, or other unsaturated rubber, in styrene monomer before initiating the polymerization reaction. Polystyrene forms the continuous phase of the polymer and the rubber phase exists as discrete particles having occlusions of polystyrene. HIPS resin is further described on pages 194-199 in Engineering Plastics, referenced above. HIPS resins are commercially available or can be readily prepared from known techniques by those skilled in the art.

Amorphous thermoplastic polymers of acrylics, which are extrusion and injection molding grade, that are useful herein are well known in the art. Amorphous thermoplastic acrylic polymers comprise a broad array of polymers in which the major monomeric constituents belong to two families of ester-acrylates and methacrylates. Amorphous thermoplastic acrylic polymers are described on pages 103-108 in Engineering Plastics, referenced above. The molecular weight of the amorphous thermoplastic polymer of acrylics, for it to be injection moldable by standard present techniques, should not be greater than 200,000. Amorphous thermoplastic acrylic polymers are commercially available or can be readily prepared from known techniques by those skilled in the art.

Amorphous thermoplastic copolymers of styrene maleic anhydride that are useful herein are well known in the art. Styrene maleic anhydride copolymers are produced by the reaction of styrene monomer with smaller amounts of maleic anhydride. Amorphous thermoplastic styrene maleic anhydride copolymers are further described on pages 217-221 in Engineering Plastics, referenced above. They are commercially available or can be prepared from known techniques by those skilled in the art.

Amorphous thermoplastic polysulfones that are useful herein are well known in the art. It is produced from bisphenol A and 4,4′-dichlorodiphenylsulfone by nucleophilic displacement chemistry. It is further described on pages 200-202 in Engineering Plastics, referenced above. Polysulfone is commercially available or can be readily prepared from known techniques by those skilled in the art.

Amorphous thermoplastic styrene acrylonitrile maleic anhydride copolymers and styrene acrylic copolymers that are useful herein are known in the art. They are commercially available or can be prepared from known techniques by those skilled in the art.

The amorphous thermoplastic polymers may also contain those additional ingredients, modifiers, stabilizers, and additives commonly included in such polymers.

It is noted here that the addition of any of styrene acrylonitrile copolymers, acrylonitrile-butadiene-styrene copolymers, acrylonitrile-ethylene-butadiene-styrene copolymers, and polycarbonates to polyoxymethylene alone reduces the mold shrinkage of the polyoxymethylene.

Optional Thermoplastic Crystalline Polymer Resin Component

Crystallinity in a thermoplastic polymer resin can be detected by any of several techniques readily available to those skilled in the art. Such techniques include the analysis for the presence of a crystalline melting point, as detected by Differential Scanning Calorimetry (DSC) or other thermal techniques, analysis for optical birefringance as measured by microscopic means, or analysis for x-ray diffraction effects typical of the crystalline state. It is noted that it is well known that although the thermoplastic resins described below are commonly referred to in the art as crystalline resins, these thermoplastic resins are known to be, in actuality, only partially crystalline and the fraction of crystallinity present in each thermoplastic resin can be changed somewhat by various processing conditions.

Other Components

It should be understood that the blends of the present invention can include, in addition to the polyacetal, the thermoplastic polyurethane, and the at least one amorphous or semi-crystalline polymer, other additives, modifiers, and ingredients as are generally used in polyacetal molding resins or in the individual components of the blend themselves, including stabilizers and co-stabilizers (such as those disclosed in U.S. Pat. Nos. 3,960,984; 4,098,843; 4,766,168; 4,814,397; and especially those disclosed in co-pending U.S. patent application Ser. Nos. 07/327,664 and 07/366,558 (i.e., non-meltable polymer stabilizers containing formaldehyde reactive hydroxy groups or formaldehyde reactive nitrogen groups or both and stabilizer mixtures containing said polymer stabilizers); and Ser. Nos. 07/483,603 and 07/483,606 (i.e., microcrystalline or fibrous cellulose and stabilizer mixtures containing either type of cellulose)); antioxidants (especially amide-containing antioxidants such as N,N′-hexamethylenebis(3,5-di-tert-butyl4-hydroxyhydrocinnamide and mixtures thereof), epoxy compounds, mold release agents, pigments, colorants, UV stabilizers (especially benzophenones and benzotriazoles and mixtures thereof), hindered amine light stabilizers (especially those containing triazine functionality), toughening agents, nucleating agents (including talc and boron nitride), glass, minerals, lubricants (including silicone oil), fibers (including glass and polytetrafluoroethylene fibers), reinforcing agents, and fillers. It should also be understood that some pigments and colorants can, themselves, adversely affect the stability of polyacetal compositions but that the physical properties should remain relatively unaffected.

It is noted that polyacetal polymer can be readily de-stabilized by compounds or impurities known to de-stabilize polyacetal. Therefore, although it is not expected that the presence of these components or impurities in the present blends will exert a major influence on the toughness and elongation properties of the blend, it is recommended that if maximum stability, such as oxidative or thermal stability, is desired for the blend, then the components of the blend, along with any additives, modifiers, or other ingredients, should be substantially free of such de-stabilizing compounds or impurities. Specifically, for blends containing ester-capped or partially ester-capped polyacetal homopolymer, stability will be increased as the level of basic materials in the individual components and other ingredients/additives/modifiers of the blend is decreased. It is further noted that polyacetal copolymer or homopolymer that is substantially all ether-capped can tolerate higher concentrations of basic materials without decreasing stability than can ester-capped or partially ester-capped polyacetal homopolymer. Further, and again for maximum stability, but not for the retention of physical properties, blends containing either homopolymer or copolymer polyacetal will have increased stability as the level of acidic or ionic impurities in the individual components and other ingredients/additives/modifiers of the blend is decreased.

Additional Layer Component

Generally the substrate of the present invention may be coated or overmolded with paints, thermoplastic elastomers, glues and the like.

The adhesion of the at least one additional discontinuous or co-continuous layer to the substrate is promoted due to the presence and distribution of the at least one amorphous or semi-crystalline thermoplastic plus, perhaps, a thermoplastic polyurethane elastomer on or near the surface of the substrate as described above.

Examples of suitable materials for overmolding include, but are not limited to, both polar and non-polar materials. Such non-polar materials include, but are not limited to, thermoplastic olefins (TPO), Kraton®, thermoplastic elastomers (TPE-S), polyethylene and polypropylene. Such polar materials include, but are not limited to, thermoplastic polyurethanes (TPU), Surlyn®, Hytrel® and polar olefins.

Examples of suitable materials for printing/painting may include solvents, water latex, epoxy, urethane, powder coating acrylic and the like.

Examples of suitable materials for gluing includes solvent-based glues, latex, epoxy, super glue and the like.

Various conventional methods may be used to adhere the at least one additional layer to the substrate including, but not limited to, wet painting, powder coating, two-shot molding, insert molding, co-extrusion, gluing and metalizing.

Wet painting methods utilize either water-based or solvent-based paints that are applied via those methods known in the art such as spraying, brushing and the like.

Powder coating methods that are well known in the art, such as, for example, dipping in a fluidized bed or electrostatic fluidized beds or electrostatic spraying use a finely divided, dry solid resinous powder that may be a paint or another plastic and can be deposited on the surface of the substrate and then cured/molten at elevated temperatures.

Two-shot molding methods are well known in the art and are typically carried out wherein one part of a cavity is filled with substrate material out of a first barrel of the 2-shot injection molding machine, then the mould opens and rotates or sliders open to modify the cavity and after closing the mold again, this new cavity is filled with layer material from a second barrel.

Insert molding methods are well known in the art and may utilize conventional molding machines, wherein the molded parts are then inserted, either manually or automatically, into another mold where the layer material is molded “on top” or around the substrate (this technique requires that the part is ejected from the mold between the 2 steps; in the method above, the part is not ejected between the 2 shots.

Co-extrusion methods, well known to those skilled in the art, allow for the extrusion of films, sheets, profiles, tubing, wire coatings and extrusion coatings.

Gluing may be performed by any method known in the art, including manual and/or mechanical methods.

Metalizing methods include those well known in the art, such as, for example, electroplating including, but not limited to, chrome plating wherein the process utilizes a mixture of chemical and electrochemical methods for the deposition of various layers.

Method of Preparation

The blends of the present invention are preferably prepared by tumbling or mixing together pellets, or some other similar article, of the individual components, and then intimately melt blending the mixture in an intensive mixing device. In other words, the components may be mixed and melt blended together or individually. It is also possible to prepare the blends by melting and mixing pellets of each individual component in a molding machine, provided sufficient mixing can occur in the molding machine.

Regardless of the method used to make the blend, melt blending should be done by any intensive mixing device capable of developing high shear at temperatures above the softening points of the individual components, but also at temperatures below which significant degradation of the polymer blend components will occur. Examples of such devices include rubber mills, internal mixers such as “Banbury” and “Brabender” mixers, single or multiblade internal mixers with a cavity heated externally or by friction, “Ko-kneaders”, multibarrel mixers such as “Farrell Continuous Mixers”, injection molding machines, and extruders, both single screw and twin screw, both co-rotating and counter rotating. These devices can be used alone or in combination with static mixers, mixing torpedoes and/or various devices to increase internal pressure and/or the intensity of mixing such as valves, gates, or screws designed for this purpose. It is preferred to use a mixing device that will achieve intimate mixing the greatest efficiency, consistency and evenness. Accordingly, continuous devices are preferred; and twin screw extruders, particularly those incorporating high intensity mixing sections such as reverse pitch elements and kneading elements, are especially preferred.

Generally, the temperature at which the blends are prepared is the temperature at which polyacetal is melt processed. Polyacetal compositions are usually melt processed at 170° C.-260° C., with 185° C.-240° C. being more preferred, and 200° C.-230° C. being most preferred. Melt processing temperatures below 170° C. or above 260° C. are possible if throughput is adjusted to compensate and if unmelted or decomposed product is not produced.

Shaped articles made from blends of the present invention can be made by any of several common methods, including compression molding, injection molding, extrusion, blow molding, melt spinning and thermoforming. Injection molding is especially preferred. Examples of shaped articles include sheet, profiles, rod stock, film, filaments, fibers, strapping, tape, tubing and pipe. Such shaped articles can be post treated by orientation, stretching, coating, annealing, painting, laminating and plating. Articles of the present invention can be ground and remolded.

Generally, the conditions used in the preparation of shaped articles will be similar to those described above for melt compounding. More specifically, melt temperatures and residence times can be used up to the point at which significant degradation of the composition occurs.

Preferably, the melt temperature will be about 170° C.-250° C., more preferably about 185° C.-240° C., and most preferably about 200° C.-230° C. Generally, the mold temperature will be 10° C.-120° C., preferably 10° C.-100° C., and most preferably the mold temperature will be about 50° C.-90° C. Generally, total hold-up time in the melt will be about 3-15 minutes, with the shorter times being preferred, consistent with giving a high quality shaped article. If the total hold-up time in the melt is too long, the various phases can degrade and/or coalesce. As an example, the standard 0.32 cm (⅛ in) thick test specimen used in the Izod tests reported later in this application were, unless otherwise specified, prepared in a 6 ounce Van Dorn reciprocating screw injection molding machine, model 150-RS-3 (Van Dorn Corporation, Cleveland Ohio) using cylinder temperature settings between 180° C.-210° C., with a mold temperature of 60° C., a back pressure of 0.3 MPa (50 psi), a screw speed of 120 rpm, a cycle of between 25 seconds injection/30 seconds hold, a ram speed of about 0.5-2 seconds, a mold pressure of 8-14 kpsi, and a general purpose screw. Total hold-up time of the melt was estimated to be about five minutes. Samples were allowed to stand for at least three days between molding and testing.

### EXAMPLES

The present invention is further defined in the following Examples, in which all parts and percentages are by weight. It should be understood that these Examples, while indicating preferred embodiments of the invention, are given by way of illustration only. From the above discussion and these Examples, one skilled in the art can ascertain the essential characteristics of this invention, and without departing from the spirit and scope thereof, can make various changes and modifications of the invention to adapt it to various usage and conditions.

Generally, the adhesion factor of the paint/printing layers was determined using a cross-hatch paint adhesion test.

Typically, the cross-hatch adhesion test (DIN EN ISO2409 as well as a modified version of ASTM-D3359-83, Method B) was conducted, such that a substrate was formed and subsequently coated with a paint. One hundred small squares (about 1/16 inches×1/16 inches) were cut into the adhered layer by making two cuts with a bladed device (e.g.

Gardco® Model P-A-T Cutter Blades, manufactured by Gardco Corporation), at a 90 degree angle. The depth of the cuts was carefully monitored so as to ensure that the cuts penetrated only the adhered layer and did not extend to any significant depths into the substrate. A quantity of suitable tape, for example Permacel 99 Tape (manufactured by Permacel Corporation, New Brunswick, N.J.), was then applied over the area cut into squares on the coated substrate so the entire area being assessed was covered. The tape was then removed and the degree of flaking of the paint due to the tape removal was assessed. A modification to the ASTM D 3359 test was made in the classification of the adhesion test results. The tests according to the present invention used a value of “0” to classify those samples in which no flaking had occurred, and thus showed the greatest level of adhesion, while a value of “5” was assigned in those instances where flaking of greater than 65% had been found. This reversal of the usual ASTM rating correlated to the otherwise identical ISO method.

### Example 1

Substrates were formed having the compositions described by the Sample Types described in Table 1. In some instances, multiple substrates having the same composition were formed and tested twice using paint K as the adhered layer. The substrates were tested using the above-noted cross-hatch procedure. The results show that the substrates of Sample Types 1-22 are able to have a paint layer applied to their surface, wherein there was adhesion between the substrate and the adhered layer.

Table 1 shows the weight percent of each component in the concentrate for Samples 1-22, along with the cross-hatch test results for each paint (i.e. Paint B and Paint K). In the table, COMPAT stands for compatibilizer; CONC stands for concentrate, and not measured is denoted by n.m. Ten percent concentrate was added to all compositions. Table 1 indicates in Samples 18-20 that the POM in the concentrate was Type 4 and rear fed into the extruder rather then fed into the side of the extruder as with all the other samples. The three comparative samples in Table 1 are 100% POM (no concentrate).

In Table 1, those values under the Paint K column marked with an asterisk (*) indicate that two sets of bar shaped samples were tested at two different times. Three to five sets of cross-hatching tests were done on each of these two sets of samples. Those tested twice are denoted by the two values in the K column, as shown by samples 14, 16 and 17.

TABLE 1

| | | type | | | | | | | |
|---|---|---|---|---|---|---|---|---|---|
| | % | of | | | % | type of | | | |
| | POM | POM | % | type of | OTHER | OTHER | added | | |
| | in | in | COMPAT | COMPAT | in | in | to POM | | |
| Sample | CONC | CONC | in CONC | in CONC | CONC | CONC | matrix | PAINT B | PAINT K |
| 1 | — | — | — | — | — | — | Type 1 | 5 | n.m. |
| (comparative) | | | | | | | | | |
| 2 | — | — | — | — | — | — | Type 2 | 5 | n.m. |
| (comparative) | | | | | | | | | |
| 3 | — | — | — | — | — | — | Type 3 | n.m. | 2 |
| (comparative) | | | | | | | | | |
| 4 | 40 | Type 4 | 10 | Type (i) | 50 | Type a | Type 2 | 5 | 1 |
| 5 | 40 | Type 4 | 10 | Type (i) | 50 | Type b | Type 2 | 5 | 1 |
| 6 | 40 | Type 4 | 10 | Type (i) | 50 | Type c | Type 2 | 5 | 1 |
| 7 | 40 | Type 4 | 10 | Type (i) | 50 | Type d | | 5 | 1 |
| 8 | 40 | Type 4 | 40 | Type (i) | 20 | Type c | Type 1 | 5 | 0 |
| 9 | 40 | Type 4 | 40 | Type (i) | 20 | Type c | Type 1 | 5 | n.m. |
| 10 | 40 | Type 4 | 10 | Type (i) | 50 | Type c | Type 1 | 5 | 1 |
| 11 | 40 | Type 4 | 10 | Type (i) | 50 | Type c | Type 1 | 5 | n.m. |
| 12 | 40 | Type 5 | 10 | Type (i) | 50 | Type d | Type 5 | 0 | n.m. |
| 13 | 30 | Type 5 | — | — | 70 | Type e | Type 5 | 1 | n.m. |
| 14 | 30 | Type 4 | — | — | 70 | Type e | Type 1 | n.m. | 2, 1* |
| 15 | 10 | Type 2 | 30 | Type (i) | 60 | Type f | Type 2 | 5 | 1 |
| 16 | 10 | Type 4 | 10 | Type (i) | 80 | Type f | Type 1 | n.m. | 1, 0* |
| 17 | 10 | Type 2 | 10 | Type (i) | 80 | Type f | Type 1 | n.m. | 2, 0* |
| 18 | 10 | Type 4 | 10 | Type (i) | 80 | Type b | Type 2 | n.m. | 0 |
| | | RF | | | | | | | |
| 19 | 10 | Type 4 | 10 | Type (i) | 80 | Type f | Type 2 | n.m. | 1 |
| | | RF | | | | | | | |
| 20 | 10 | Type 4 | 10 | Type (i) | 80 | Type a | Type 2 | n.m. | 0 |
| | | RF | | | | | | | |
| 21 | 10 | Type 4 | 10 | Type (i) | 80 | Type a | Type 2 | n.m. | 1 |
| 22 | 10 | Type 5 | 30 | Type (i) | 60 | Type f | Type 5 | 1 | n.m. |

Polyacetal Component:

Type 1—nucleated polyacetal homopolymer (MW=38,000).

Type 2—polyacetal homopolymer (MW=65,000).

Type 3—polyacetal homopolymer (MW=38,000).

Type 4—polyacetal copolymer with 4.5% ethylene oxide groups (MN=22,000).

Type 5—polyacetal homopolymer (MW=65,000) with UV package.

Compatibilizer Components:

Type (i)—a thermoplastic polyurethane with butylene adipate soft segments and 4,4′ methylene bisphenyl isocyanate.

Type (ii)—polycaprolactone (MW=37,000)

Other Components:

Type a—a 41% PBT hard segment/59% ethylene oxide-polypropylene oxide soft segment.

Type b—a polymethyl methacrylate/methacrylic acid 98/2 (MW=35,000)

Type c—poly methyl mathacrylate/methacrylic acid 98/2 (MW=8000).

Type d—nylon 66/610/6 melting point of 154° C. (Mn=40,000).

Type e—polycaprolactone (MW=37,000)

Type f—an extrusion grade ABS (melt flow=3.9)

Paints for Which Adhesion was Tested

Type B—Rust-oleum Hard Hat, spray, finish ACABADO safety blue V2124

Type K—Tamiya Europe GMBH, TS-5 Olive Drab

What is claimed is:

1. A method for producing a substrate comprising the steps of:
(a) forming a polyacetal polymer matrix comprising about 85% to about 98% of a polyacetal;
(b) adding about 2% to about 15% of a concentrate to the polyacetal matrix, wherein the concentrate comprises about 0% to about 40% of a thermoplastic polyurethane and about 20% to about 80% of at least one amorphous or semi-crystalline polymer, in polyacetal and wherein a substrate is formed; and
(c) molding the substrate.

2. The method according to claim 1, wherein the polyacetal polymer is a branched or linear polymer having a number average molecular weight in the range of about 10,000 to about 100,000.

3. The method according to claim 2, wherein the polyacetal polymer is a homopolymer, a copolymer or a mixture thereof.

4. The method according to claim 3, wherein the homopolymer has terminal hydroxyl groups having been end-capped by a group selected from esters or ethers.

5. The method according to claim 4, wherein the ester group is an acetate group.

6. The method according to claim 4, wherein the ether group is a methoxy group.

7. The method according to claim 1, wherein the polyacetal matrix further comprises at least one stabilizer.

8. The method according to claim 1, wherein the concentrate is in the form of at least one pellet.

9. The method according to claim 1, wherein the at least one amorphous or semi-crystalline polymer is selected from the group consisting of styrene acrylonitrile copolymers, styrene acrylonitrile copolymers toughened with acrylonitrile-butadiene-styrene resins, styrene acrylonitrile copolymers toughened with acrylonitrile-ethylene-propylene-styrene resins, polycarbonates, polyamides, polyesters, polyester-polyether copolymers, polyarylates, polyphenyleneoxides, polyphenylene ethers, high impact styrene resins, acrylic polymers, imidized acrylic resins, styrene maleic anhydride copolymers, polysulfones, styrene acrylonitrile maleic anhydride resins, styrene acrylic copolymers, and derivatives thereof.

10. The method according to claim 9, wherein the at least one amorphous or semi-crystalline polymer is selected from the group consisting of styrene acrylonitrile copolymers, acrylonitrile-butadiene-styrene resins, acrylonitril-ethylene-propylene-styrene resins, and polycarbonates, polyesters, polyester-polyether copolymers.

11. The method according to claim 1, wherein the substrate may be molded using a method selected from the group consisting of extrusion molding and injection molding.

12. A process for making an article comprising the steps of:
(i) forming the substrate according to claim 1; and
(ii) adhering at least one additional layer to the substrate.

13. The process according to claim 12, wherein the at least one additional layer is a thermoplastic olefin, thermoplastic elastomers, polyethylene, polypropylene, thermoplastic polyurethanes, polar olefins, solvents, water latex, epoxy, urethane, powder coating acrylic, solvent-based glues, latex, epoxy, paint, printing ink, and super glue.

14. The process according to claim 12, wherein the at least one additional layer is discontinuous.

15. The process according to claim 12, wherein the at least one additional layer is co-continuous.

16. An article produced according to the process of claim 12.
